(19) United States
(12) Patent Application Publication
(10) Pub. No.: US 2018/0022877 A1
(43) Pub. Date: Jan. 25, 2018

(54) METHODS OF PRODUCING STABLE LIGNIN PHENOLIC OIL

(71) Applicant: Iowa State University Research Foundation, Inc., Ames, IA (US)

(72) Inventors: Robert C. BROWN, Ames, IA (US); Marjorie R. ROVER, Ames, IA (US); Patrick H. HALL, Ames, IA (US); Ryan G. SMITH, Ames, IA (US)

(21) Appl. No.: 15/657,678

(22) Filed: Jul. 24, 2017

Related U.S. Application Data
(60) Provisional application No. 62/365,619, filed on Jul. 22, 2016.

(51) Int. Cl. C08H 7/00

(52) U.S. Cl. CPC C08H 6/00

(57) ABSTRACT

The present invention relates to a method of producing a stable lignin phenolic oil, where the method comprises providing a lignin; pre-treating the lignin with a base solution, where the base solution has a pH of 8 or above; and hydrogenating the pre-treated lignin to produce a stabilized lignin phenolic oil. The present invention further relates to a method of producing a stable lignin phenolic oil, the method comprising: providing a non-recalcitrant lignin; solubilizing the lignin in a solvent; and hydrogenating the solubilized lignin to produce a stabilized lignin phenolic oil.

This application claims the benefit of U.S. Provisional Patent Application Ser. No. 62/365,619, filed Jul. 22, 2016, which is hereby incorporated by reference in its entirety.

This invention was made with government support under Contract No. 2011-68005-30411 awarded by USDA/NIFA. The government has certain rights in the invention.

### FIELD OF THE INVENTION

The present invention relates to methods of producing stable lignin phenolic oil.

### BACKGROUND OF THE INVENTION

Lignin, an aromatic renewable resource, is a low-cost by-product from industrial streams such as cellulosic ethanol and paper and pulping industries. These streams of lignin have varying solvent solubility depending on the industrial processes used to remove the cellulose and hemicellulose from the biomass.

Lignin has enormous potential as a renewable resource for both fuels and aromatic chemicals, however, technologies of lignin valorization (i.e., adding value to a lignin) are markedly less developed than those for the cellulose portion of biomass. Azadi et al., “Liquid Fuels, Hydrogen and Chemicals From Lignin: A Critical Review,” Renewable and Sustainable Energy Reviews 21:506-523 (2013). This is attributable to difficulties in catalytic processing because of the variety of different interunit linkages, high reactivity resulting in formation of larger molecular weight moieties when further upgraded, poor product selectivity, and the ease of use as a solid fuel. These are all major obstacles toward development of lignin-based biorefining technologies. Azadi et al., “Liquid Fuels, Hydrogen and Chemicals From Lignin: A Critical Review,” Renewable and Sustainable Energy Reviews 21:506-523 (2013). Currently, the common routes for lignin conversion are synthesis gas conversion (Yoshida et al., “Partial Oxidative and Catalytic Biomass Gasification in Supercritical Water: A Promising Flow Reactor System,” Industrial & Engineering Chemistry Research 43:4097-4104 (2004); Osada et al., “Water Density Effect on Lignin Gasification over Supported Noble Metal Catalysts in Supercritical Water,” Energy & Fuels 20:930-935 (2006); and Roberts et al., “Towards Quantitative Catalytic Lignin Depolymerization,” Chemistry—A European Journal 17:5939-5948 (2011)), production of bio-oil via liquefaction (Roberts et al., “Towards Quantitative Catalytic Lignin Depolymerization,” Chemistry—A European Journal 17:5939-5948 (2011); Petrocelli et al., “Chemical Modeling Analysis of the Yields of Single-Ring Phenolics From Lignin Liquefaction,” Industrial & Engineering Chemistry Product Research and Development 24:635-641 (1985)) or fast pyrolysis (Roberts et al., “Towards Quantitative Catalytic Lignin Depolymerization,” Chemistry—A European Journal 17:5939-5948 (2011); Amen-Chen et al., “Production of Monomeric Phenols by Thermochemical Conversion of Biomass: A Review,” Bioresource Technology 79:277-299 (2001)), and hydrolysis (Roberts et al., “Towards Quantitative Catalytic Lignin Depolymerization,” Chemistry—A European Journal 17:5939-5948 (2011); Saisu et al., “Conversion of Lignin With Supercritical Water—Phenol Mixtures,” Energy & Fuels 17:922-928 (2003); Schuchardt et al., “Liquefaction of Hydrolytic Eucalyptus Lignin With Formate in Water, Using Batch and Continuous-Flow Reactors,” Bioresource Technology 44:123-129 (1993)). Hydrolysis is a milder route, whereas, the others demand severe conditions. Roberts et al., “Towards Quantitative Catalytic Lignin Depolymerization,” Chemistry—A European Journal 17:5939-5948 (2011).

Lignin has been previously depolymerized via base-catalyzed hydrothermal processing. The product is stabilized by high pressure, high temperature hydroprocessing. Product yields of this two-step process were as high as 92%, although the procedure counted both filtrate and filter cake toward the yield. The oil yield based on the monomer-rich aqueous phase was only 22 wt %. U.S. Patent Application Publication No. 2003/0100807 to Shabtai et al.; Roberts et al., “Towards Quantitative Catalytic Lignin Depolymerization,” Chemistry—A European Journal 17:5939-5948 (2011).

This low yield was attributed to polymerization of highly reactive lignin cleavage products that formed higher molecular weight moieties, coke, and lignin-like material. Roberts et al., “Towards Quantitative Catalytic Lignin Depolymerization,” Chemistry—A European Journal 17:5939-5948 (2011); Miller et al., “Batch Microreactor Studies of Lignin and Lignin Model Compound Depolymerization by Bases in Alcohol Solvents,” Fuel 78:1363-1366 (1999). To increase the yield of oil from hydrothermal lignin treatment, polymerization of the molecules must be limited. To date, many approaches have been attempted in order to stabilize the intermediate products, nonetheless, with little success. Roberts et al., “Towards Quantitative Catalytic Lignin Depolymerization,” Chemistry—A European Journal 17:5939-5948 (2011); Saisu et al., “Conversion of Lignin With Supercritical Water—Phenol Mixtures,” Energy & Fuels 17:922-928 (2003); Dutta et al., “Lignin Deconstruction Sustainable Catalytic Processes,” in SUSTAINABLE CATALYTIC PROCESSES (2015).

Conditions in the art prior for base-catalyzed depolymerization of lignin related to organosolv lignin, use a continuous-flow reactor at high temperature and pressure conditions, for example between 240° C. to 340° C. and between 250 bar to 315 bar pressure. See Roberts et al., “Towards Quantitative Catalytic Lignin Depolymerization,” Chemistry—A European Journal 17:5939-5948 (2011); Erdocia et al., “Base Catalyzed Depolymerization of Lignin: Influence of Organosols Lignin Nature,” Biomass & Bioenergy 66:379-386 (2014).

The present invention is directed to overcoming these and other deficiencies in the art.

### SUMMARY OF THE INVENTION

A first aspect of the present invention relates to a method of producing a stable lignin phenolic oil. The method includes providing a lignin; pre-treating the lignin with a base solution, where the base solution has a pH of 8 or above; and hydrogenating the pre-treated lignin to produce a stabilized lignin phenolic oil.

A second aspect of the present invention relates to a method of producing a stable lignin phenolic oil. The method includes providing a non-recalcitrant lignin; solubilizing the lignin in a solvent; and hydrogenating the solubilized lignin to produce a stabilized lignin phenolic oil.

Hydrogenation can break the double bonds found in lignins, but conventional hydroprocessing, even so-called “mild” hydroprocessing, as previously reported in the literature, is too severe for the reactive feedstocks derived from biomass. Thus, attempts at producing a stable lignin phenolic oil to date have resulted in significant reductions in yield, coking of the catalyst, and/or increased viscosity, all of which render the lignin unsuitable for use in industrial applications.

The present invention utilizes a lignin which is susceptible to direct solubilization in a solvent (for example, lignin derived from acetosolv processing) or utilizes a more recalcitrant lignin that requires pretreatment to enhance solubilization in a solvent (for example, lignin derived from enzymatic hydrolysis, supercritical hydrolysis, etc.). Secondly, the dissolved lignin streams from either kind of solubilization process are subjected to low temperature, low pressure-hydrogenation (LTLP-H) to liquefy the dissolved lignin resulting in a stable, low viscosity product at high yield after removal and recycling of the solvent. The methods of the present invention can be used to upgrade and/or stabilize lignin-derived, phenolic oil so it is suitable for use as a fuel oil or for further upgrading into higher-end products such as transportation fuels, thermoset plastics, and resins.

According to the present invention, lignin was obtained from four different types of industrial sources as follows: organosolv, supercritical hydrolysis (wet stream), supercritical hydrolysis (dry stream), and enzymatic hydrolysis, and were depolymerized by four different pre-treatments. These pre-treatments included, for example, sodium hydroxide (NaOH), ammonium hydroxide (NH₄OH), calcium hydroxide (Ca(OH)₂), and triethylamine (C₆H₁₅N). After pre-treatment, low temperature, low pressure hydrogenation (LTLP-H) was performed on soluble lignin streams at mild conditions such as room temperature and 1 atm pressure using a catalyst such as 10% Pd/C for around 16 hours. It was shown that the organosolv industrial stream resulted in a maximum liquid oil yield of 57 wt % into solution without the pretreatment (a higher yield results after pre-treatment). The other kinds of lignin were more recalcitrant as a result of higher molecular weight species in these lignins; therefore, they required a pre-treatment step before solubilization in a solvent. Pre-treatments utilized were 5% ammonium hydroxide solution and 5% calcium hydroxide solution, refluxed with the lignin for 6 hours at 125° C. The yields were lower for the supercritical lignin stream at 22 wt % liquid oil using calcium hydroxide pre-treatment while the enzymatic lignin stream produced 23 wt % with an identical pre-treatment. ¹H NMR revealed complex polymeric spectra of the lignins prior to LTLP-H with unresolved functionalities. After LTLP-H, the spectra indicated resolvable peaks, suggesting the breakage of polymeric ether bonds yielding smaller molecular weight chemical species. Resolvable functionalities included methyl and methylene groups at 0.0-1.6 ppm, methylene groups and aliphatic alcohols at 1.6-2.2.0 ppm, methyl- and benzyl-substituted aromatics and alpha carbonyls at 2.2-3.0 ppm, and lastly aliphatic protons adjacent to oxygen at 3.0-4.2 ppm.

### BRIEF DESCRIPTION OF THE DRAWINGS

FIGS. 1A-1B depict devices used for pre-treatment and hydrogenation. FIG. 1A shows a reflux apparatus used to mildly pre-treat lignins. FIG. 1B shows the low temperature, low pressure hydrogenation (LTLP-H) apparatus utilized to hydrogenate lignin streams.

FIGS. 2A-2D illustrate by ¹H NMR, the changes to lignins prior to and after LTLP-H. FIG. 2A shows results for organosolv lignin dissolved in methanol. FIG. 2B shows the comparison of the ¹H NMR spectra of dry supercritical lignin, after sodium hydroxide treatment, and after LTLP-H of the mildly pre-treated lignin streams. FIG. 2C shows the comparison of the ¹H NMR spectra of wet supercritical lignin, after sodium hydroxide treatment, and after LTLP-H of the mildly pre-treated lignin streams. FIG. 2D shows, by ¹H NMR, changes in the enzymatic hydrolysis lignin after sodium hydroxide treatment and LTLP-H pre-treated lignin.

FIGS. 3A-3D show functional group changes after specific pre-treatment and/or hydrogenation treatments. FIG. 3A depicts organosolv lignin changes after low temperature, low pressure hydrogenation (LTLP-H) in a methanol solvent, after pre-treatment, and lastly after the pre-treated organosolv lignin was subjected to LTLP-H. FIG. 3B illustrates the relative functional group changes in the dry supercritical lignins. FIG. 3C depicts the relative functional group changes in the wet supercritical lignins. FIG. 3D illustrates relative functional group changes in the enzymatic hydrolysis lignin.

FIG. 4 illustrates hydrogen/carbon molar ratios after pre-treatment and/or hydrogenation of the lignin streams.

FIG. 5 shows changes in functional groups in organosolv lignin after LTLP-H using Fourier transform infrared spectroscopy (FTIR).

FIGS. 6A-6C show thermogravimetric (TG) and derivative thermogravimetric (DTG) curves of wet supercritical hard wood lignin showing changes in the lignin during sodium hydroxide (NaOH) pre-treatment and the low temperature, low pressure-hydrogenation (LTLP-H). FIG. 6A shows curves of the wet supercritical hard wood lignin. FIG. 6B shows curves of the wet supercritical hard wood lignin after pre-treatment with NaOH. FIG. 6C shows curves of the stabilized wet supercritical hard wood lignin after LTLP-H.

FIGS. 7A-7C depict TG and DTG curves of wet supercritical hard wood lignin showing changes in the lignin during the triethylamine (Et₃N) pre-treatment and the low temperature, low pressure-hydrogenation (LTLP-H). FIG. 7A shows curves of wet supercritical hydrolysis hard wood lignin. FIG. 7B shows curves of the wet supercritical hydrolysis hard wood lignin after pre-treatment with Et₃N. FIG. 7C shows curves of the wet supercritical hydrolysis hard wood lignin after LTLP-H.

### DETAILED DESCRIPTION OF THE INVENTION

A first aspect of the present invention relates to a method of producing a stable lignin phenolic oil. The method includes providing a lignin; pre-treating the lignin with a base solution, where the base solution has a pH of 8 or above; and hydrogenating the pre-treated lignin to produce a stabilized lignin phenolic oil.

Lignin according to the present invention relates to a class of complex organic polymers which form important structural materials in the support tissues of vascular plants and some algae. Martone et al., “Discovery of Lignin in Seaweed Reveals Convergent Evolution of Cell-Wall Architecture,” Current Biology 19(2):169-75 (2009), which is hereby incorporated by reference in its entirety. Lignins are particularly important in the formation of cell walls, especially in wood and bark, because they lend rigidity and do not rot easily. Chemically, lignins are irregular, randomly cross-linked phenolic polymer units joined by various different linkages. Lebo et al., “Lignin,” Kirk-Othmer Encyclopedia of Chemical Technology, John Wiley & Sons, Inc. (2001), which is hereby incorporated by reference in its entirety. Lignin is an aromatic renewable resource and a low-cost byproduct from industrial streams such as cellulosic ethanol and paper and pulping industries. Streams of lignin according to the present invention have varying solvent solubility depending on the industrial processes used to remove the cellulose and hemicellulose from the biomass.

Lignin can be obtained from a variety of biomass types. Biomass is biological material from living, or recently living organisms. Biomass can be in the form of products, by-products, and/or residues of the forestry and agriculture industries. Biomass includes, but is not limited to, forest and mill residues, agricultural crops and wastes, wood and wood wastes, animal wastes, livestock operation residues, aquatic plants, fast-growing trees and plants, and municipal and industrial wastes. The crop residues that can be used for the present invention include materials such as, e.g., corn stover. Biomass can include cellulose, hemicelluose, and/or lignin. Lignocellulosic biomass typically refers to plant biomass. Typically, lignocellulosic biomass can include cellulose, hemicelluose, and/or lignin. Lignin includes, for example, lignocellulosic materials such as wood chips, straws, grasses, corn stover, corn husks, weeks, aquatic plants, hay, paper, paper products, recycled paper and/or other paper products, and other cellulose containing biological materials or materials of biological origin.

Lignin in accordance with the present invention accounts for 23-33% of the mass of soft woods and 16%-25% of the mass of hard woods. Mohan et al., “Pyrolysis of Wood/Biomass for Bio-Oil: A Critical Review,” Energy & Fuels 20:848-889 (2006), which is hereby incorporated by reference in its entirety. It is the main binder for agglomeration of fibrous cellulosic components while also providing a shield against the rapid microbial or fungal destruction of the cellulosic fibers. Lignin is a three-dimensional, highly branched, polyphenolic substance that consists of an irregular array of variously bonded “hydroxy-” and “methoxy-” substituted phenylpropane units. These three general monomeric phenylpropane units exhibit the p-coumaryl, coniferyl, and sinapyl structures. In lignin biosynthesis, these units undergo radical dimerization and further oligomerization, and they eventually polymerize and cross-link.

Various lignins (e.g., hard wood and soft wood lignins) in accordance with the present invention have different structures. Mohan et al., “Pyrolysis of Wood/Biomass for Bio-Oil: A Critical Review,” Energy & Fuels 20:848-889 (2006), which is hereby incorporated by reference in its entirety. “Guaiacyl” lignin, which is found predominantly in soft woods, results from the polymerization of a higher fraction of coniferyl phenylpropane units. “Guaiacyl-syringyl” lignin, which is typically found in many hard woods, is a copolymer of both the coniferyl and sinapyl phenylpropane units where the fraction of sinapyl units is higher than in soft wood lignins. Lignin has an amorphous structure, which leads to a large number of possible interlinkages between individual units, because the radical reactions are nonselective random condensations. Ether bonds predominate between lignin units, unlike the acetal functions found in cellulose and hemicellulose, but carbon-to-carbon linkages also exist.

The physical and chemical properties of lignins in accordance with the present invention may differ, depending on the extraction or isolation technology used to isolate them. The lignins of the present invention may, in one embodiment, contain contaminants or other products such as, for example, unconverted sugar and sugar precursors, ash, and other solids.

The present invention may produce stable lignin phenolic oil using a recalcitrant lignin and a non-recalcitrant lignin. Recalcitrant lignins in accordance with the present invention include those which do not dissolve in a short-chain alcohol (such as, for example, C₁ to C₆ alcohol and a C₂ to C₆ ether, including methanol, ether, and 1,4-dioxane), without a base pre-treatment. Examples of recalcitrant lignins according to the present invention include, but are not limited to, lignins produced by supercritical hydrolysis of hard wood, supercritical hydrolysis of switchgrass, and enzymatic hydrolysis of corn stover. Non-recalcitrant lignins in accordance with the present invention include those lignins which dissolve in a short-chain alcohol (such as, for example, C₁ to C₆ alcohol and a C₂ to C₆ ether, including methanol, ether, and 1,4-dioxane) to some extent without a base pre-treatment. Examples of non-recalcitrant lignins include, but are not limited to, organosolv (e.g., corn stover) lignin. However, by subjecting a non-recalcitrant lignin to a base pre-treatment in accordance with the present invention, the yield of liquid product may increase, whereas the yield of liquid product without the base pretreatment may in some embodiments decrease. In an alternative embodiment of the present invention, a recalcitrant ligand may be provided. In yet another embodiment of the present invention, a non-recalcitrant ligand may be provided.

In one embodiment, the lignin may be selected from the group consisting of organosolv lignin, Kraft lignin, supercritical hydrolysis lignin, steam explosion lignin, enzymatic hydrolysis lignin, acetosolv lignin, milled wood lignin, and black liquor lignin. For example, the lignin may be derived from the organosolv process, which is an extraction procedure using organic solvents, supercritical hydrolysis including both a wet stream and a dry stream, and enzymatic hydrolysis.

The organosolv process for lignins is an organosolv treatment that has been used to separate cellulose, hemicellulose, and lignin from lignocellulosic material by taking advantage of the higher affinity for the lignin oligomers to dissolve in organic solvents. Hernandez-Hernandez et al., “Acetosolv Treatment of Fibers From Waste Agave Leaves: Influence of Process Variables and Microstructural Study,” Industrial Crops and Products 86:163-172 (2016), which is hereby incorporated by reference in its entirety. Conventional acetosolv processes are generally focused on the production of pulp from woody lignocelluloses. Li et al., “Mild Acetosolv Process To Fractionate Bamboo for the Biorefinery: Structural and Antioxidant Properties of the Dissolved Lignin,” J. Agric. Food Chem. 60(7):1703-12 (2012), which is hereby incorporated by reference in its entirety. The organosolv methods may be effective for separation of the main components of lignocellulosic materials and as pre-treatment for the enzymatic hydrolysis of cellulose (Zhao et al., “Organosolv Pretreatment of Lignocellulosic Biomass for Enzymatic Hydrolysis,” Appl. Microbiol. Biotechnol. 85: 815-827 (2009), which is hereby incorporated by reference in its entirety). A variety of organic solvents, including alcohols and aliphatic acids, can be utilized as pulping agents. Soudham et al., “Acetosolv Delignification of Marabou (Dichrostachys cinerea) Wood With and Without Acid Prehydrolysis,” For. Stud. China 13(1):63-70 (2011), which is hereby incorporated by reference in its entirety. The acetosolv process utilizes acetic acid in delignification in HCl-catalyzed media. In one embodiment, an organosolv lignin is used.

Supercritical hydrolysis for lignin of the present invention is a process by which water in the supercritical state can be employed to achieve a variety of reactions within seconds using dry hard wood or wet hard wood. To cope with the extremely short times of reaction on an industrial scale, the process is preferably continuous. This continuity minimizes the energy needed to heat the water above the critical point. Application of the process to biomass provides simple sugars in near quantitative yield by supercritical hydrolysis of the constituent polysaccharides. The phenolic polymer components of the biomass, exemplified by lignins, are converted into a water-insoluble liquid mixture of low molecular phenols. Renmatix™, based in King of Prussia, Pa., has developed a supercritical hydrolysis technology to convert a range of non-food biomass feedstocks into cellulosic sugars for application in biochemicals and biofuels. In one embodiment, a Renmatix™ dry lignin is used. In another embodiment, a Renmatix™ wet lignin is used.

Enzymatic hydrolysis for lignin according to the present invention relates to a process in which enzymes facilitate the cleavage of bonds in molecules of lignin such as corn stover with the addition of the elements of water. In one embodiment, an enzymatic hydrolysis lignin is used.

Lignins according to the present aspect are pre-treated with a base solution, where the base solution has a pH of 8 or above. In one embodiment, the pre-treatment may be carried out by treating the lignin with a hydroxide solution.

The base solution of the present aspect of the invention has a pH of 8 or above. In some embodiments, the pH may be above 9, above 10, above 11, above 12, above 13, or above 14. In one embodiment, the pH of the base solution is between 8 and 11.

Examples of base solution pre-treatment in accordance with the present invention include solutions of sodium hydroxide (NaOH), ammonium hydroxide (NH₄OH), and calcium hydroxide (Ca(OH)₂). The pre-treatment may in certain embodiments comprise, for example, treatments with solutions of sodium hydroxide (NaOH), calcium hydroxide (CaOH₂), ammonium hydroxide (NH₄OH), or triethylamine (C₆H₁₅N or Et₃N). In one embodiment, the method includes treating the lignin or lignin phenolic oil with an agent selected from the group consisting of triethylamine (C₆H₁₅N or Et₃N), sodium carbonate, sodium bicarbonate, alcohols, and boric acid.

In one embodiment, the base solution used for lignin pre-treatment may comprise a hydroxide solution. For example, the hydroxide can be selected from the group consisting of sodium hydroxide, ammonium hydroxide, calcium hydroxide, triethylamine hydroxide, potassium hydroxide, lithium hydroxide, and magnesium hydroxide. The hydroxide may be in solution with water. In one embodiment, the hydroxide is present in the hydroxide solution in a concentration of 1 to 25%. In another embodiment, the hydroxide is present in the hydroxide solution in a concentration of about 5% or about 10%. For example, in certain embodiments, the hydroxide solution may comprise 5% sodium hydroxide (NaOH) solution (by weight) with water, 5% calcium hydroxide (CaOH₂) solution (by weight) with water, 10% ammonium hydroxide (NH₄OH), solution (by weight) with water. In one embodiment, the NaOH and CaOH₂ may be held at 125° C. during a reflux, and the reflux may in some embodiments, last up to about 6 hours. In one embodiment, the NH₄OH may be held at 125° C. for 4 hours, then raised to 140° C. for 2 hours.

In one embodiment, the base solution is triethylamine (C₆H₁₅N or Et₃N). The Et₃N solution may comprise, for example, 10% Et₃N solution by weight with water. Alternatively, the Et₃N solution may comprise more than 10% solution by weight with water, for example between 10% to 50% solution by weight with water. The Et₃N solution may, alternatively, comprise less than 10% solution by weight with water, for example between 1 and 10%, more specifically up to 9%, up to 8%, up to 7%, up to 6%, up to 5%, up to 4%, up to 3%, up to 2%, or up to 1% Et₃N solution by weight with water. In one embodiment, the base solution may comprise 10% triethylamine (Et₃N) solution (by weight) with water refluxed for 6 hours. In one embodiment, the Et₃N may be held at 125° C. for 4 hours, then raised to 140° C. for 2 hours.

The concentration of the base may be, for example, up to 1%, up to 2%, up to 3%, up to 4%, up to 5%, up to 6%, up to 7%, up to 8%, up to 9%, up to 10%, up to 15%, up to 20%, up to 25%, up to 30%, or more than 30% in the base solution. In one embodiment, the base is present in the base solution in a concentration of between 1% to 25%. In another embodiment, the base is present in the base solution in a concentration of about 5% or about 10%.

The pre-treatment step may be carried out at a temperature between 15° C. and 200° C. For example, the temperature of the pre-treatment step may be carried out at a temperature of up to 15° C., up to 20° C., up to 25° C., up to 30° C., up to 35° C., up to 40° C., up to 45° C., up to 50° C., up to 55° C., up to 60° C., up to 65° C., up to 70° C., up to 75° C., up to 80° C., up to 85° C., up to 90° C., up to 95° C., up to 100° C., up to 105° C., up to 110° C., up to 115° C., up to 120° C., up to 125° C., up to 130° C., up to 135° C., up to 140° C., up to 145° C., up to 150° C., up to 155° C., up to 160° C., up to 165° C., up to 170° C., up to 175° C., up to 180° C., up to 185° C., up to 190° C., up to 195° C., or up to 200° C.

The pre-treatment step may be carried out for a time of no less than 15 minutes. The time required for the pre-treatment step may be, for example, at least 15 minutes, at least 20 minutes, at least 25 minutes, at least 30 minutes, at least 35 minutes, at least 40 minutes, at least 45 minutes, at least 50 minutes, at least 55 minutes, at least 60 minutes, at least 65 minutes, at least 70 minutes, at least 75 minutes, at least 80 minutes, at least 85 minutes, at least 90 minutes, at least 95 minutes, at least 100 minutes, at least 110 minutes, at least 120 minutes, at least 125 minutes, at least 130 minutes, at least 135 minutes, at least 140 minutes, at least 145 minutes, at least 150 minutes, at least 155 minutes, at least 160 minutes, at least 165 minutes, at least 170 minutes, at least 175 minutes, at least 180 minutes, at least 185 minutes, at least 190 minutes, at least 195 minutes, at least 200 minutes, at least 210 minutes, at least 220 minutes, at least 230 minutes, at least 240 minutes, at least 250 minutes, at least 260 minutes, at least 270 minutes, at least 280 minutes, at least 290 minutes, at least 300 minutes, at least 310 minutes, at least 320 minutes, at least 330 minutes, at least 340 minutes, at least 350 minutes, at least 360 minutes, or more than 360 minutes. In one embodiment, the pre-treatment step may be carried out at a temperature of between 15° C. and 200° C. for a time of no less than 15 minutes. In another embodiment, the pre-treating is carried out at a temperature of between 100° C. to 150° C. and for a time of between 2 hours and 6 hours. In one embodiment, the temperature of the pre-treatment may change after a period of time, either raised to a higher temperature, or alternatively, changed to a lower temperature for a subsequent period of time.

Additives may be included in the lignin or lignin phenolic oil in some embodiments to facilitate stabilization. Examples of such additives include, but are not limited to, surfactants, anti-flocculants, anticoagulants, solvents, acids, bases, and salts. Examples of surfactants include but are not limited to anionic surfactants, nonionic surfactants, cationic surfactants, and may act as detergents, wetting agents, emulsifiers, foaming agents, and dispersants.

Agitation of the lignin streams before and during pre-treatment may, in some embodiments, be used.

The pre-treated lignin of the present aspect of the invention is subjected to low temperature, low pressure-hydrogenation (LTLP-H) to liquefy the dissolved lignin into stable oil that can be further upgraded into, for example, higher-end products such as transportation fuels, thermoset plastics, and resins.

The LTLP-H may last for at least 5 minutes, at least 30 minutes, at least 1 hour, at least 2 hours, at least 3 hours, at least 4 hours, at least 5 hours, at least 6 hours, at least 7 hours, at least 8 hours, at least 9 hours, at least 10 hours, at least 11 hours, at least 12 hours, at least 13 hours, at least 14 hours, at least 15 hours, at least 16 hours, or longer. In one embodiment, the LTLP-H is performed for approximately 16 hours. Following LTLP-H, samples may be filtered and the residue dried and weighed. The water may be removed from liquid product via rotary evaporated at 70 mbar and 40° C.

The LTLP-H used may be carried out at a temperature of less than 150° C. The temperature of the LTLP-H may be, for example, less than 149° C., less than 145° C., less than 140° C., less than 135° C., less than 130° C., less than 125° C., less than 120° C., less than 115° C., less than 110° C., less than 105° C., less than 100° C., less than 95° C., less than 90° C., less than 85° C., less than 80° C., less than 75° C., less than 70° C., less than 65° C., less than 60° C., less than 55° C., less than 50° C., less than 45° C., less than 40° C., less than 35° C., less than 30° C., less than 25° C., less than 24° C., less than 23° C., less than 22° C., less than 21° C., less than 20° C., less than 15° C., less than 10° C., less than 5° C., or less than 5° C.

The LTLP-H used may be carried out at a pressure of less than 100 bar absolute. The pressure of the LTLP-H may be, for example, less than 99 bar absolute, less than 95 bar absolute, less than 90 bar absolute, less than 85 bar absolute, less than 80 bar absolute, less than 75 bar absolute, less than 70 bar absolute, less than 65 bar absolute, less than 60 bar absolute, less than 55 bar absolute, less than 50 bar absolute, less than 45 bar absolute, less than 40 bar absolute, less than 35 bar absolute, less than 30 bar absolute, less than 25 bar absolute, less than 20 bar absolute, less than 15 bar absolute, less than 10 bar absolute, less than 9 bar absolute, less than 8 bar absolute, less than 7 bar absolute, less than 6 bar absolute, less than 5 bar absolute, less than 4 bar absolute, less than 3 bar absolute, less than 2 bar absolute, less than 1.9 bar absolute, less than 1.8 bar absolute, less than 1.7 bar absolute, less than 1.6 bar absolute, less than 0.5 bar absolute, less than 1.4 bar absolute, less than 1.3 bar absolute, less than 1.2 bar absolute, less than 1.1 bar absolute, less than 1 bar absolute, less than 0.9 bar absolute, less than 0.8 bar absolute, less than 0.7 bar absolute, less than 0.6 bar absolute, less than 0.5 bar absolute, less than 0.4 bar absolute, less than 0.3 bar absolute, less than 0.2 bar absolute, less than 0.1 bar absolute, or below 0.1 bar absolute.

In one embodiment, the hydrogenating (e.g., LTLP-H) is carried out at a temperature of less than 150° C. and at a pressure of less than 100 bar (absolute). In another embodiment, the hydrogenating is carried out at a temperature of 10° C. to 100° C. In yet another embodiment, the hydrogenating is carried out at a pressure of 0.05 bar (absolute) to 50 bar (absolute). The hydrogenating may, in another embodiment, be carried out at a temperature of 15° C. to 50° C. and a pressure of 0.5 bar (absolute) to 10 bar (absolute). In another embodiment, the hydrogenating is carried out at a temperature of 20° C. to 25° C. and a pressure of about 1 bar (absolute). The low-temperature, low-pressure hydrogenation used may, in one embodiment, be carried out at ambient pressure and temperature.

The LTLP-H may, in one embodiment, be carried out in the presence of a catalyst. Catalysts useful for LTLP-H (i.e., LTLP-H catalysts) may be used without limitation, provided the required conversion and environmental stability (e.g., maintenance of catalytic activity, resistance to fouling, poisoning, and the like) and the desired performance under the reaction conditions are met. The LTLP-H catalyst may be used as a heterogeneous or homogeneous catalyst, or a combination. Non-limiting examples of suitable catalysts may include one or more transition metals from group 3 to group 12, more specifically metals comprising group 9 or 10 metals, for example cobalt or palladium, respectively, or a platinum group metal (e.g., palladium, platinum, rhodium, ruthenium, iridium and osmium).

Preferred catalysts are based on palladium, preferably supported on porous carbon. Although a mono-metallic catalyst of the group 10 metal, e.g., Pd based catalyst, is preferred, a bi-metallic catalyst (e.g., Ni—Zr, Ni—Ce, Ni—Ce—Zr, Ni—Cr, Ni—Mo, Ni—W, Ni—Mn, Ni—Re, Ni—Fe, Ni—Ru, Ni—Cu, Co—Mo) can also be used.

In one embodiment, the catalyst is Pd, Ru, Ru+Pd, Pt, Raney Ni, Ni, CoMo, or NiMo. Preferably, the catalyst comprises Pd. In one embodiment, the catalyst is palladium on activated carbon catalyst (Pd/C).

The catalyst may include the catalyst metal present in an amount of up to 10 weight percent (wt %) based on the total weight of catalyst metal and support. In one embodiment, the hydrogenation catalyst metal is present in an amount of 0.1 to 10 wt %, specifically 1 to 10 wt %, more specifically 1.5 to 10 wt %, and still more specifically 5 to 10 wt %, based on the total weight of LTLP-H catalyst and support. The catalyst may have a surface area of 800 to 2,000 m²/g and a particle size corresponding to an average largest dimension of the particle of less than or equal to 50 μm, specifically 1 to 40 μm, where a powdered catalyst is used; or alternatively, in another embodiment, less than or equal to about 5 mm, where a granular support is desired. It will be appreciated by one skilled in the art that the particular size, surface area, and quantity of the LTLP-H catalyst used will be determined by the skilled practitioner as required by the needs of the particular application.

For example, a 10% Pd/C catalyst may be used for, e.g., high activity, mild process conditions, carbon support availability, and the recovery of Pd metal by simply burning off the carbon support (Panpranot et al., Applied Catalysis A: General 292:322-327 (2005); Harada et al., Journal of Molecular Catalysis A: Chemical 268:59-64 (2007); Numwong et al., “Partial Hydrogenation of Polyunsaturated Fatty Acid Methyl Esters Over Pd/Activated Carbon: Effect of Type of Reactor,” Chemical Engineering Journal 210:173-181 (2012), which are hereby incorporated by reference in their entirety). In one embodiment, the LTLP-H may be performed on soluble lignin at room temperature and 1 atm pressure using 10% Pd/C catalyst for 16 hours. The catalyst may, alternatively, be used for less than 16 hours, for example, less than 15 hours, less than 14 hours, less than 13 hours, less than 12 hours, less than 11 hours, less than 10 hours, less than 9 hours, less than 8 hours, less than 7 hours, less than 6 hours, less than 5 hours, less than 4 hours, less than 3 hours, less than 2 hours, less than 1 hours, or for less than 1 hour.

Support materials are chosen to bring the active (metal) phase of the catalyst into contact with reactants. Non-limiting examples of suitable catalyst support materials include one or more of, e.g., carbon supports, alumina supports, silica supports, titanium supports, zirconia supports, niobium pentoxide materials, ceria supports, silica-alumina, silica nitride, boron nitride, zeolites, and calcium supports. In particular, exemplary supports for the catalyst include, but are not limited to, C, Al₂O₃, SiO₂, Al₂O₃+SiO₂, CaCO₃, TiO₂, ZrO₂, and Nb₂O₅.

Preferably, the support material is porous carbon (such as activated carbon). This support shows no tendency to hydrolyze and deteriorate in water and acid rich environments. A further benefit of carbon-supported catalyst is the low cost of the carbon support and the ability to recover metals from spent catalysts by simply burning off the carbon, rather than more expensive refining or recovery processes.

The resulting stabilized lignin phenolic oil may have a lower viscosity than a non-pre-treated, LTLP-H lignin phenolic oil (e.g., at least 5% lower, at least 10% lower, at least 15% lower, at least 20% lower, at least 25% lower, at least 30% lower, at least 35% lower, at least 40% lower, at least 45% lower, at least 50% lower, at least 55% lower, at least 60% lower, at least 65% lower, at least 70% lower, at least 75% lower, at least 80% lower, at least 85% lower, at least 90% lower, or at least 95% lower than the non-pre-treated, LTLP-H lignin phenolic oil). Alternatively, the resulting stabilized lignin phenolic oil may have a higher viscosity than a non-pre-treated, LTLP-H lignin phenolic oil (e.g., at least 5% higher, at least 10% higher, at least 15% higher, at least 20% higher, at least 25% higher, at least 30% higher, at least 35% higher, at least 40% higher, at least 45% higher, at least 50% higher, at least 55% higher, at least 60% higher, at least 65% higher, at least 70% higher, at least 75% higher, at least 80% higher, at least 80% higher, at least 90% higher, or at least 95% higher than the non-pre-treated, LTLP-H lignin phenolic oil).

Given the efficient recovery of carbon using the methods of producing a stable lignin phenolic oil disclosed herein, i.e., about 50-100% of carbon may be returned from the lignin. In addition, the stabilized lignin phenolic oil may contain substantially no coke and/or substantially no carbon gases and/or substantially no phenolic molecule polymers.

In one embodiment, the stabilized lignin phenolic oil has a product yield of over 50%. In another embodiment, the stabilized lignin phenolic oil has a product yield of over 55%, over 60%, over 65%, over 70%, over 75%, over 80%, over 85%, or over 90%. In one embodiment, the stabilized lignin phenolic oil contains a reduced number of polymeric ether bonds compared to the lignin prior to pre-treating the lignin. The methods result in a stable lignin phenolic oil where polymeric ether bonds are broken and small molecular weight chemical species are produced.

Additionally, the stable lignin phenolic oil may, in some embodiments, contain fewer vinyl groups, ether groups, and/or aldehydes than the untreated lignin. Moreover, the stable lignin phenolic oil may contain increased aliphatics, phenolic monomers, and/or alcohols compared to the untreated (non-hydrogenated) lignin. For example, resolvable functionalities may include methyl and methylene groups at 0.0-1.6 ppm, methylene groups and aliphatic alcohols at 1.6-2.2.0 ppm, methyl- and benzyl-substituted aromatics and alpha carbonyls at 2.2-3.0 ppm, and aliphatic protons adjacent to oxygen at 3.0-4.2 ppm. In another embodiment, the stabilized lignin phenolic oil contains methyl and methylene groups, methylene groups and aliphatic alcohols, methyl- and benzyl-substituted aromatics and alpha carbonyls, and aliphatic protons adjacent to oxygen.

In some aspects, the lignin can be further stabilized and/or upgraded to further reduce the presence of reactive groups, e.g., by reacting the stabilized lignin phenolic oil with zinc and hydrochloric acid at a temperature of less than 0° C. In one aspect, hydrogenated lignin phenolic oil can be further processed by such reaction with Zn and HCl. Moreover, lignin phenolic oil may be further upgraded and/or stabilized to reduce the presence of reactive carbonyl groups by fermentation.

A second aspect of the present invention relates to a method of producing a stable lignin phenolic oil. The method includes providing a non-recalcitrant lignin; solubilizing the lignin in a solvent; and hydrogenating the solubilized lignin to produce a stabilized lignin phenolic oil.

The non-recalcitrant lignin of the present aspect is solubilized in a solvent. In one embodiment, the solvent is selected from group consisting of a C₁ to C₆ alcohol and a C₂ to C₆ ether. Other examples of solvents that may be used in accordance with the present invention include, but are not limited to, acetic acid, acetone, acetonitrile, benzene, 1-butanol, 2-butanol, 2-butanone, t-butyl alcohol, carbon tetrachloride, chlorobenzene, chloroform, cyclohexane, 1,2-dichloroethane, diethylene glycol, diethyl ether, diglyme, 1,2-dimethoxy-ethane, dimethyl-formamide, dimethyl sulfoxide, 1,4-dioxane, ethanol, ethyl acetate, ethylene glycol, glycerin, hexamethylphosphoramide, hexamethylphosphorous triamide, hexane, methanol, methyl-t-butyl ether, methylene chloride, N-methyl-2-pyrrolidinone, nitromethane, pentane, petroleum ether, 1-propanol, 2-propanol, pyridine, tetrahydrofuran, toluene, triethyl amine, water, o-xylene, m-xylene, and p-xylene, among others. In one embodiment, the solvent may be selected from group consisting of methanol and 1,4-dioxane.

In one embodiment, the non-recalcitrant lignin is an organosolv lignin in accordance with the previously described aspect.

The hydrogenating in the present aspect of the invention is carried out in accordance with the previously described aspect (e.g., LTLP-H described above). In one embodiment, the stabilized lignin phenolic oil contains a reduced number of polymeric ether bonds compared to the non-recalcitrant lignin prior to solubilizing the lignin.

This aspect is carried out in accordance as previously described.

The above disclosure generally describes the present invention. A more specific description is provided below in the following examples. The examples are described solely for the purpose of illustration and are not intended to limit the scope of the present invention. Changes in form and substitution of equivalents are contemplated as circumstances suggest or render expedient. Although specific terms have been employed herein, such terms are intended in a descriptive sense and not for purposes of limitation.

### EXAMPLES

The following examples are intended to illustrate, but by no means are intended to limit, the scope of the present invention as set forth in the appended claims

### Materials and Methods

Pre-Treatment and Low Temperature, Low Pressure-Hydrogenation (LTLP-H) of Industrial Lignin Streams.

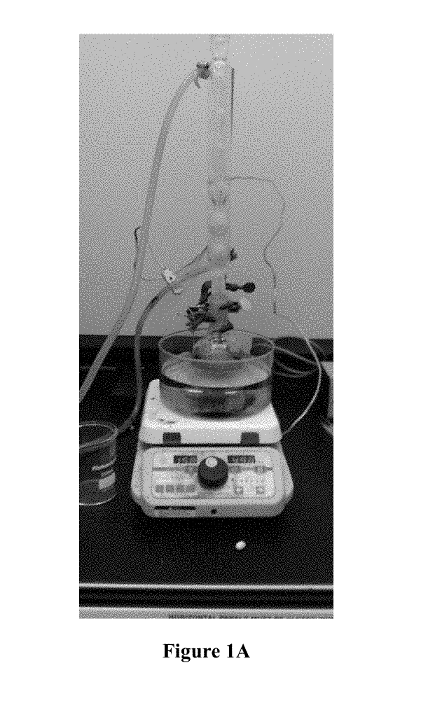

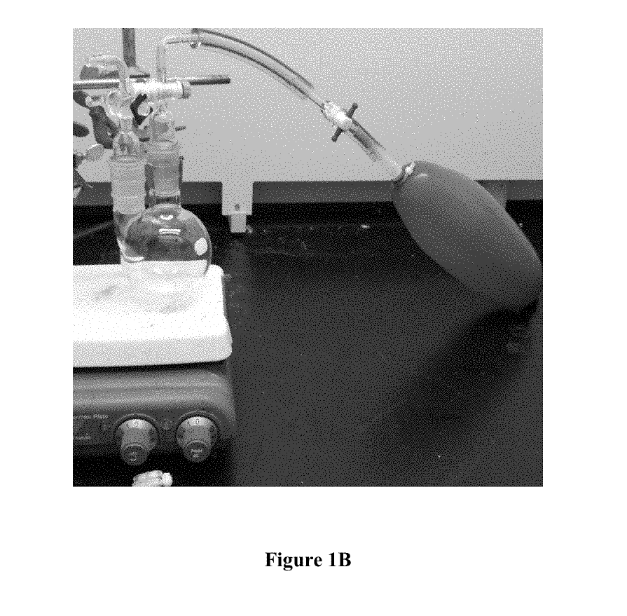

The lignin sample pre-treatment consisted of 5% sodium hydroxide (NaOH) solution (by weight) with water, or a 5% calcium hydroxide (Ca(OH)₂) solution (by weight) with water, or 10% ammonium hydroxide (NH₄OH), solution (by weight) with water, or 10% triethylamine (Et₃N) solution (by weight) with water under reflux for 6 hours (FIG. 1A). The NaOH and Ca(OH)₂ were held at 125° C. during the reflux. The NH₄OH and Et₃N were held at 125° C. for 4 hours and raised to 140° C. for two hours.

After refluxing 0.2 g of 10% palladium on carbon catalyst were added to the samples and placed in either a three-armed round bottom flask or a two-armed round bottom flask (FIG. 1B). Two balloons filled with hydrogen were added to two of the arms and a stopper placed in the third for three-armed flask or the two balloons were placed on the two arms of the two-armed flask. Two balloons were used because the samples consumed more hydrogen than one balloon could provide. The round bottom flask with the hydrogen balloons was allowed to sit for 16 hours to hydrogenate the samples at room temperature and pressure. A stir bar was used to keep the pre-treated lignin stirring. After 16 hours, the samples were filtered and the residue dried and weighed. The catalyst weight was subtracted from the solid residue weights for mass balance. The water was removed from liquid product via rotary evaporated at 70 mbar and 40° C. Moisture content of the liquid product was determined by Karl Fischer for determination of dry basis.

### Example 1—Product Yields of Industrial Lignin Streams Subjected to Mild Pre-Treatment with Sodium Hydroxide, Ammonium Hydroxide, Calcium Hydroxide, or Triethylamine

The NaOH treatment gave high overall product yields for all lignins (Table 1).

TABLE 1
Product yields on a dry basis of the industrial lignin streams subjected to mild
pre-treatment using 5% sodium hydroxide followed by low temperature, low pressure
hydrogenation (LTLP-H).

| | | Supercritical | Supercritical | | |
|---|---|---|---|---|---|
| | | Hydrolysis | Hydrolysis | Enzymatic | Supercritical |
| | Organosolv | (dry hard | (wet hard | Hydrolysis | Hydrolysis |
| Lignin | (Wood) | wood) | wood) | (corn stover) | (switchgrass) |
| Product | 96.7 | 104.7 | 98.6 | 103.7 | 101 |
| yield | | | | | |
| Oil yield | 87.9 | 98.4 | 90.9 | 88.0 | 81.5 |
| (wt % db) | | | | | |
| Solids yield | 8.86 | 6.30 | 7.68 | 15.6 | 19.5 |
| (wt % db) | | | | | |

The NaOH pre-treatment did have approximately twice the solids yields for the enzymatic hydrolysis lignin. This lignin is from corn stover which would be expected to produce higher solids yields due to higher mineral matter (catalyze polymerization reactions) within this type of biomass versus woody biomass lignin. The enzymatic hydrolysis switchgrass lignin also shows higher solids content and lower liquid oil yields, as well, for similar reasons. The samples that gave product yields over 100% may be due to moisture remaining in the sample.

The NH₄OH pre-treatment followed by LTLP-H gave low solids yield for the organosolv, supercritical hydrolysis (dry), and the enzymatic hydrolysis lignins, as shown in Table 2, below, at 43.2, 13.1, and 15.5 wt %, respectively.

TABLE 2
Yields of total product, phenolic oil, and solids from
industrial lignin streams subjected to mild pre-treatment
using 5% ammonium hydroxide followed with low
temperature, low pressure hydrogenation (LTLP-H)
on wet basis (wb).

| | | | Supercritical | |
|---|---|---|---|---|
| | Organosolv | Supercritical | Hydrolysis | Enzymatic |
| | (corn | Hydrolysis | (wet hard | Hydrolysis |
| Lignin | stover) | (dry hard wood) | wood) | (corn stover) |
| Total | 108.4 | 127.4 | 98.2 | 87.7 |
| product | | | | |
| yield | | | | |
| Phenolic | 65.2 | 114.3 | N/A | 72.2 |
| oil yield | | (likely contains | | |
| (wt % wb) | | moisture) | | |
| Solids | 43.2 | 13.1 | N/A | 15.5 |
| yield | | | | |
| (wt % wb) | | | | |

The NH₄OH pre-treatment followed by LTLP-H gave low solids yields for the organosolv, supercritical hydrolysis (dry), and the enzymatic hydrolysis lignins, as shown in Table 2, at 43.2, 13.1, and 15.5 wt %, respectively. The NH₄OH pre-treatment would not interfere with zeolite catalyst for upgrading to olefins and aromatics, ultimately these could be further upgraded to fuels in a petroleum refinery catalytic cracker. The ammonium hydroxide pre-treatment followed by LTLP-H for the enzymatic hydrolysis lignin gave a high oil yield of 72.2 wt % with an overall mass yield of oil and solids at 87.7 wt %. The supercritical hydrolysis dry lignin also gave low percentages of solids at 13.1 wt %. The oil yield appeared to contain moisture resulting in an overestimation of yield.

Calcium hydroxide pre-treatment appeared to be the least effective of the three pre-treatments evaluated (Table 3). The yields were lower for the supercritical lignin stream at 21.7 wt % liquid oil using calcium hydroxide pre-treatment while the enzymatic lignin stream produced 22.5 wt % with an identical pre-treatment.

TABLE 3
Yields of total product, phenolic oil, and solids from industrial
lignin streams subjected to mild pre-treatment using calcium
hydroxide followed by low temperature, low pressure
hydrogenation (LTLP-H).

| | Supercritical Hydrolysis | Enzymatic Hydrolysis |
|---|---|---|
| Lignin | (dry hard wood) | (corn stover) |
| Total product yield | 100.3 | 105.6 |
| Oil yield (wt % wb) | 21.7 | 22.5 |
| Solids yield (wt % wb) | 78.6 | 83.1 |

Due to NH₄OH pre-treatment leaving the reflux distillation apparatus as gas, the pre-treatment was switched to C₆H₁₅N pre-treatment. As indicated by the results below, this type of pre-treatment is very promising. As shown in Table 4, the oil yield is very high except for the corn stover enzymatic hydrolysis lignin. It shows a liquid oil yield of 48.9 wt %.

TABLE 4
Yields of total product, phenolic oil, and solids from
industrial lignin streams subjected to mild pre-treatment
using 10% triethylamine followed by low temperature,
low pressure hydrogenation (LTLP-H) on dry basis (db).

| | | Supercritical | Supercritical | Enzymatic |
|---|---|---|---|---|
| | | Hydrolysis | Hydrolysis | Hydrolysis |
| | Organosolv | (dry hard | (wet hard | (corn |
| Lignin | (wood) | wood) | wood) | stover) |
| Total product | 102.9 | 102.6 | 92.7 | 95.9 |
| yield (db) | | | | |
| Oil yield | 93.0 | 93.4 | 81.5 | 48.9 |
| (wt % db) | | | | |
| Solids yield | 9.92 | 9.13 | 11.3 | 47.0 |
| (wt % db) | | | | |

### Example 2—Product Yields of Organosolv Lignin Dissolved in Methanol or 1,4-Dioxane Solvents

The organosolv lignin dissolved in both methanol and 1,4-dioxane, as previously stated. LTLP-H was performed on the organosolv lignin with no pre-treatment. The organosolv lignin was dissolved at two different methanol dilutions and a 1,4-dioxane dilution. Table 5 indicates that LTLP-H worked well to form liquid oil from the dry lignin. It also shows that there is an optimum amount of methanol needed to help in the hydrogenation reaction to form oil. When using 20 mL of methanol with 10 g dry lignin, the oil yield was 36.3 wt %. On the other hand, when using 9.5 g dry lignin with 100 mL methanol, there was 57.2 wt % oil produced during LTLP-H. This may require further optimization. To determine if the methanol is simply being lost or if the lignin is utilizing the solvent during the reaction to form esters, 1,4-dioxane was used as solvent (it would not react with the lignin during LTLP-H). As shown by the percentage of solvent recovered, it appears that losses during the handling resulted in similar solvent recoveries between the methanol and the 1,4-dioxane. This gives evidence that the methanol is not being consumed in larger volumes by the reaction.

TABLE 5
Comparison of yields of total product, phenolic oil, and solids
from organosolv lignin dissolved in methanol or 1,4-dioxane
solvents and subjected to low pressure, low temperature
hydrogenation (LTLP-H).

| | Organosolv | Organosolv | Organosolv |
|---|---|---|---|
| | (9.545 g | (10.064 g | (24.96 g |
| | lignin/100 mL | lignin/20 mL | lignin/250 mL 1,4- |
| Lignin | methanol) | methanol) | dioxane) |
| Total product | 102.4 | 97.3 | 113.2 |
| yield | | | |
| Oil yield (wt %) | 57.2 | 36.3 | 73.3 |
| Solids yield (wt %) | 45.2 | 61.0 | 39.9 |
| Solvent recovered | 72 | 90 | 69 |
| (%) | | | |

### Example 3—Structure Changes of Lignin Dissolved in Methanol or 1,4-Dioxane Solvents after Low Temperature, Low Pressure Hydrogenation (LTLP-H)

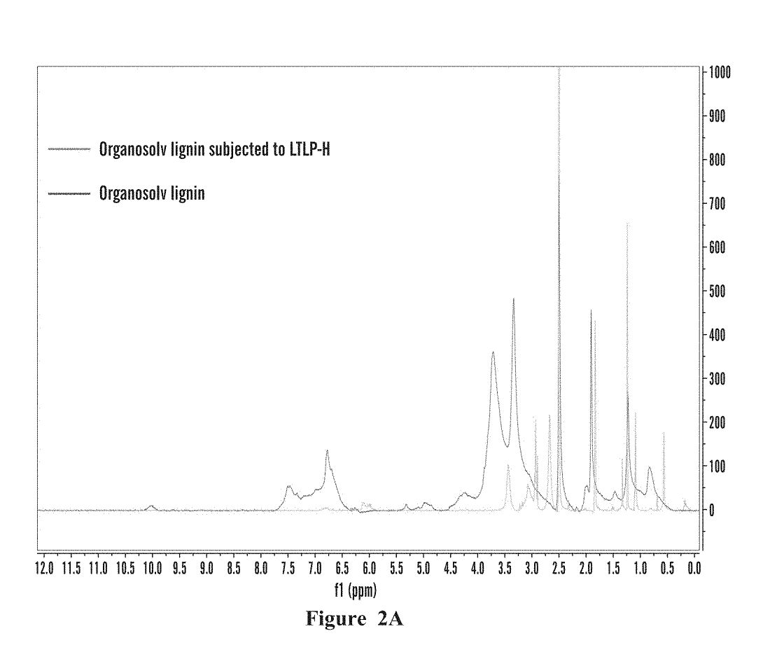

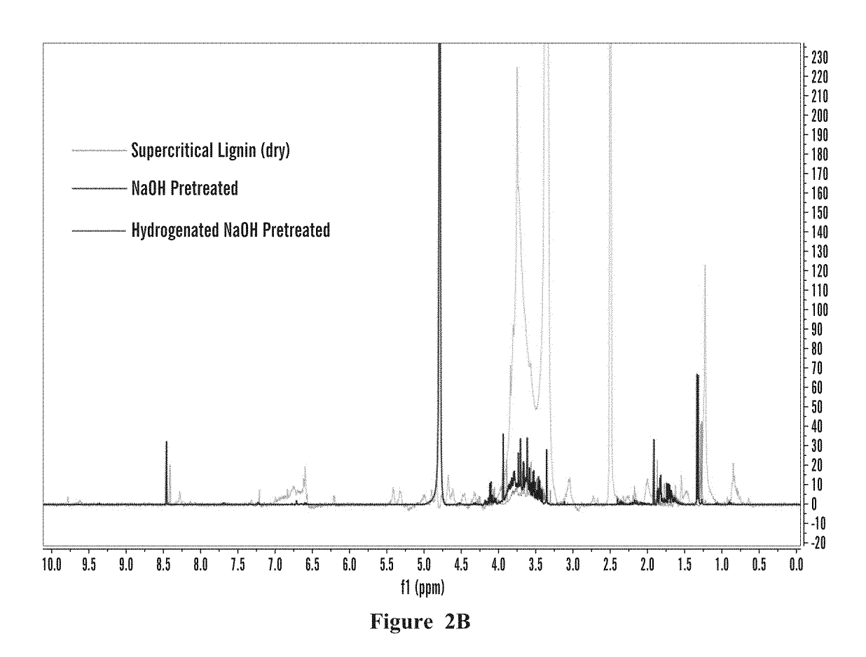

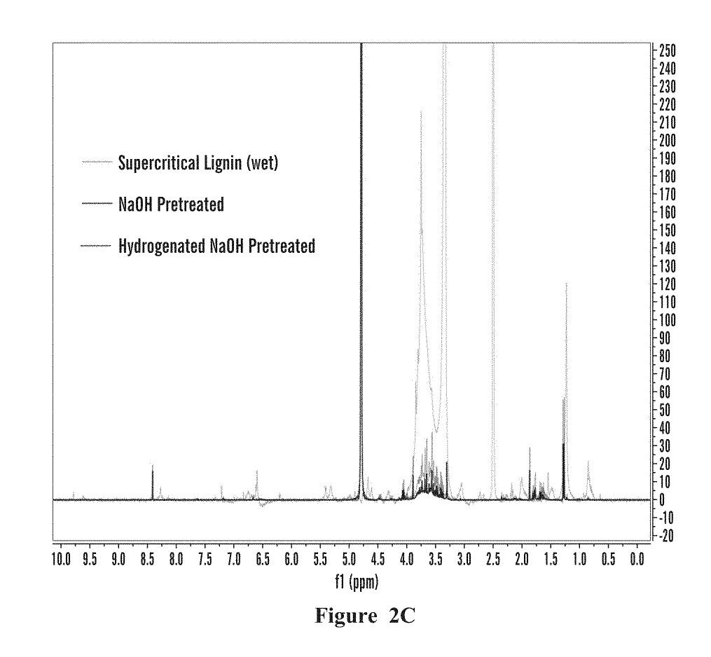

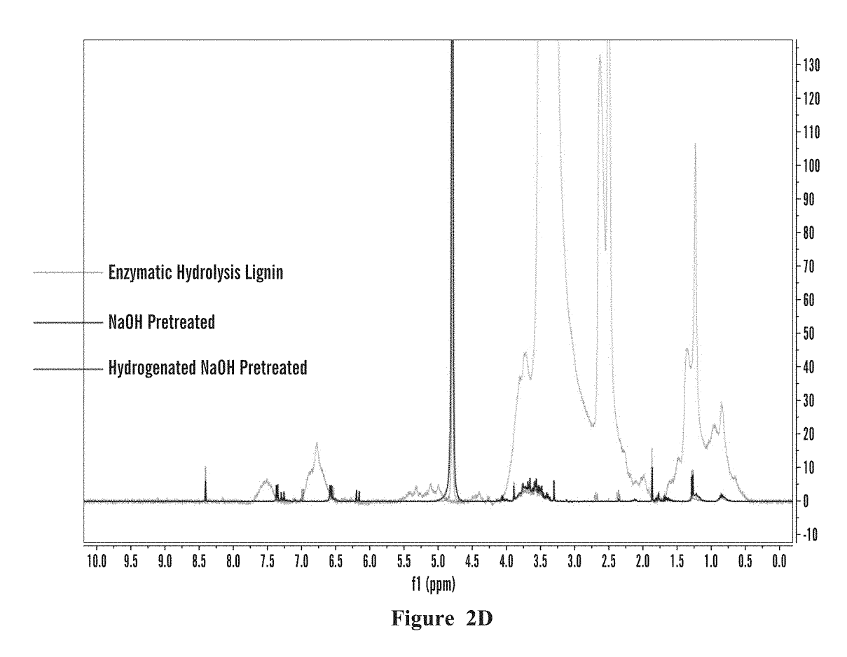

¹H NMR indicates dramatic structure changes after low temperature, low pressure hydrogenation (LTLP-H) (FIG. 2A). ¹H NMR revealed complex polymeric spectra of the lignins prior to LTLP-H with unresolved functionalities. After LTLP-H, the spectra indicated resolvable peaks suggesting the breakage of polymeric ether bonds yielding smaller molecular weight chemical species (FIGS. 2A-2D). Resolvable functionalities included methyl and methylene groups at 0.0-1.6 ppm, methylene groups and aliphatic alcohols at 1.6-2.2.0 ppm, methyl- and benzyl-substituted aromatics and alpha carbonyls at 2.2-3.0 ppm, and lastly aliphatic protons adjacent to oxygen at 3.0-4.2 ppm.

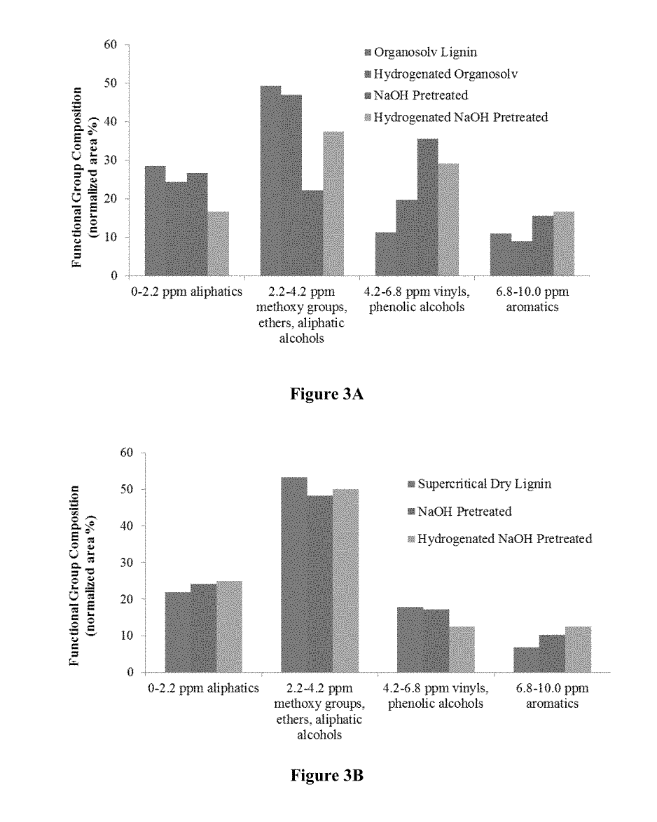

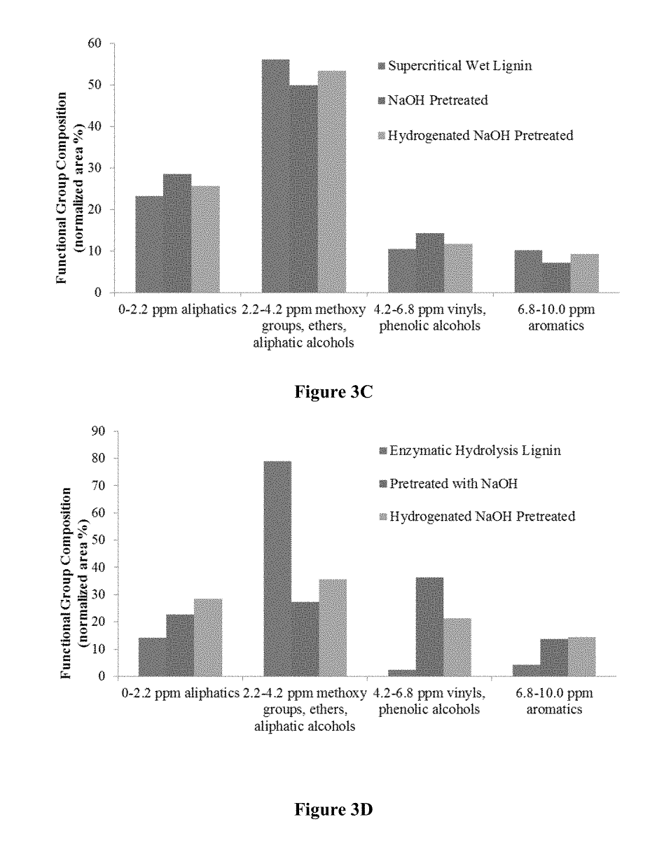

The functional group changes were also determined for the lignins using normalized area percent of the ¹H NMR spectra (FIGS. 3A-3D). The organosolv lignin showed losses of aliphatics and increases in vinyls/phenolic alcohols (most likely in phenolic alcohols because vinyls are reactive double bonds that would be hydrogenated during LTLP-H), and aromatics after LTLP-H of the pre-treated lignin. The organosolv lignin that was dissolved in methanol and then subjected to LTLP-H showed positive changes in the aliphatics and the vinyls/phenolic alcohols (most likely in phenolic alcohols). There were decreases in the methoxyl groups/ethers/aliphatic alcohols and lastly in the aromatic region (FIG. 3A). The supercritical hydrolysis lignins (dry and wet) indicated increased aliphatics and aromatics in the dry (FIG. 3B) while the wet (FIG. 3C) indicated increases in the aliphatics and vinyls/phenolic alcohols. Results for the enzymatic hydrolysis lignin showed increases in the aliphatics vinyls/phenolic alcohols, and aromatics (FIG. 3D).

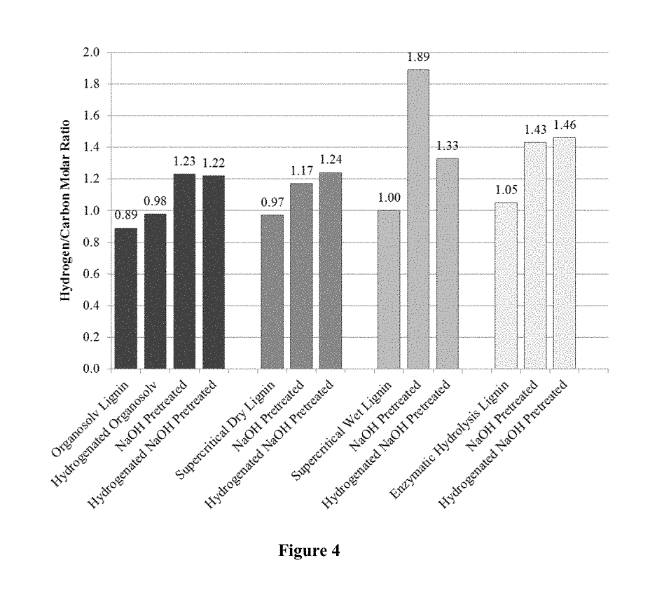

The H/C molar ratios increased with the pre-treatments and with pre-treatment and LTLP-H (FIG. 4). An increase in these molar ratios is important when upgrading to fuels. The most dramatic increase is in the enzymatic hydrolysis lignin after pre-treatment and LTLP-H.

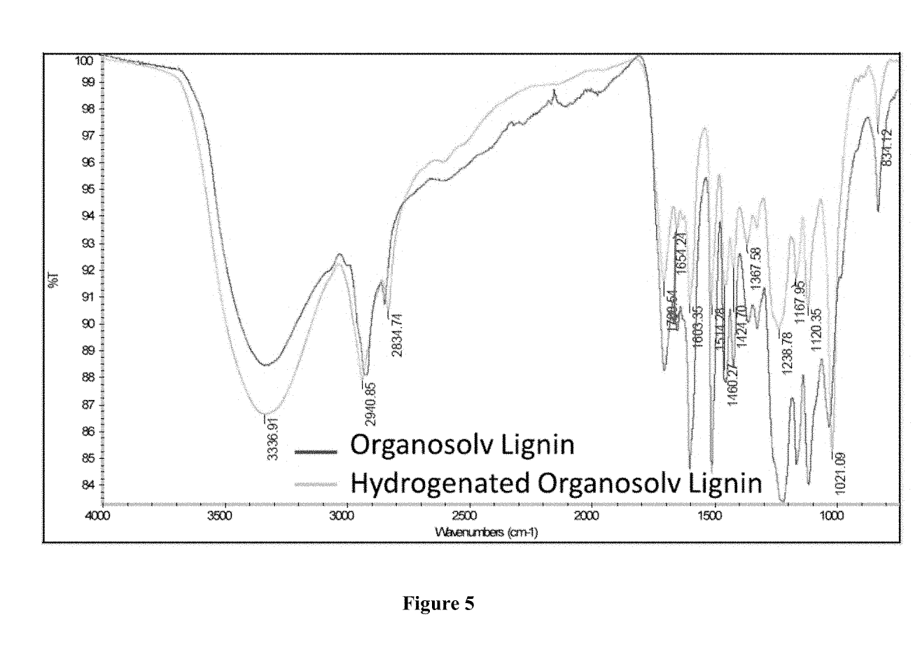

Fourier transform infrared spectroscopy (FTIR) showed changes in functional groups in the organosolv lignin after LTLP-H. As shown in FIG. 5, the wavenumber 1021 cm⁻¹ indicated an increase in OH groups in alcohols, phenols, and/or CH—O—H in cyclic alcohols in the LTLP-H sample. The 2940 and 2834 cm⁻¹ wavenumbers show slight increases in aliphatic CH₂ and CH₃ groups. There was a decrease in carbonyl groups as well as benzene rings in aromatics in the LTLP-H sample shown at the wavenumber ranges of 1710-1424 cm⁻¹.

### Example 4—Mass Loss of Lignin Low Temperature, Low Pressure Hydrogenation (LTLP-H)

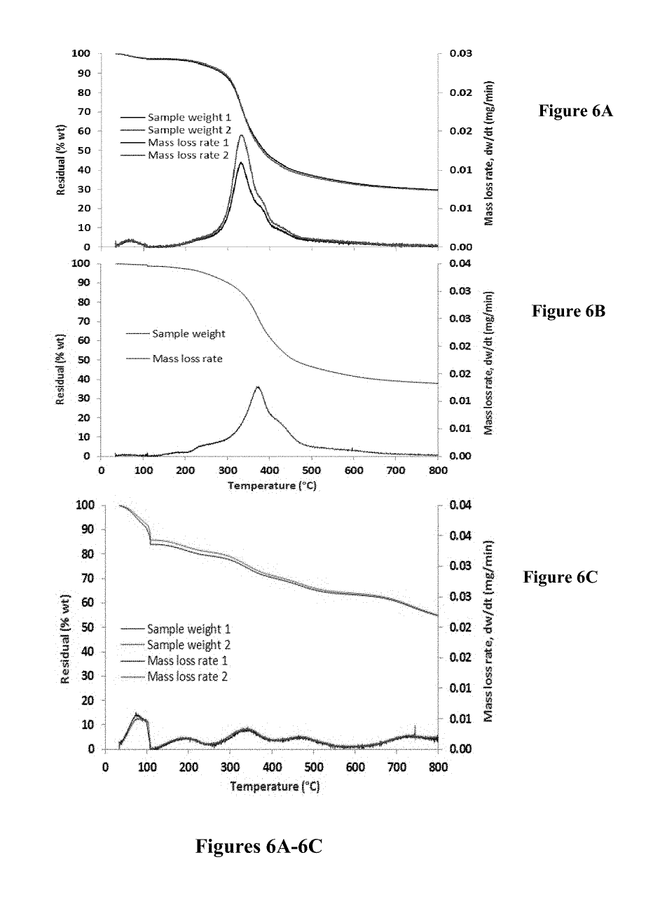

The thermogravimetric (TG) curve of the wet supercritical hard wood lignin indicates rapid mass loss at 300-400° C. (FIG. 6A). After pre-treatment with NaOH, there is rapid mass loss from 300-500° C. (FIG. 6B). When stabilized using LTLP-H, the mass loss is gradual from 100-800° C. (FIG. 6C). Looking at the derivative thermogravimetric (DTG) curve indicates the moisture loss at 100° C. with rapid mass loss at 350° C. (FIG. 6A). Sodium hydroxide pre-treatment shows rapid degradation at 375° C. with areas of gradual degradation at 175-300° C. and 400-500° C. (FIG. 6C). After LTLP-H, the DTG curve shows a moisture loss at 100° C. followed by degradation at 200° C., 350° C., 450° C., and 750° C.

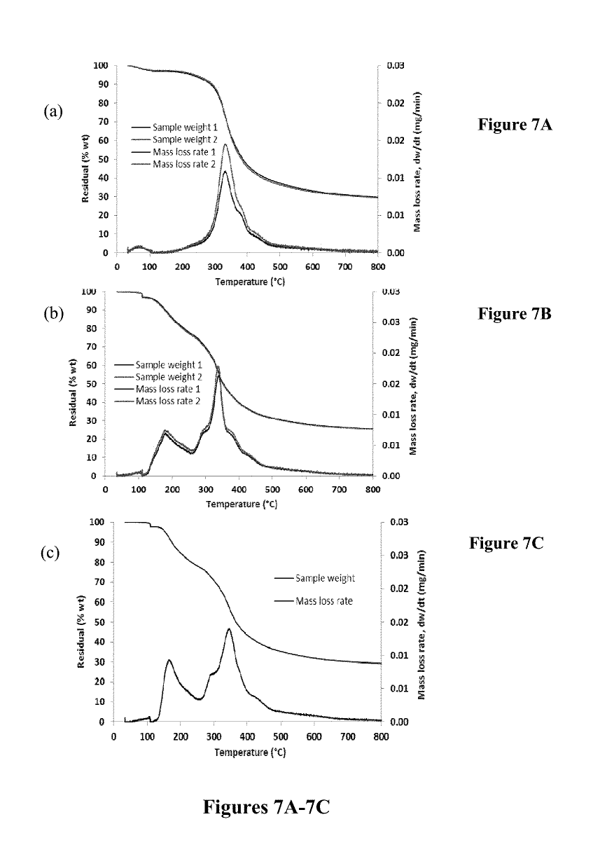

The thermogravimetric (TG) curve of the wet supercritical hydrolysis hard wood lignin indicated rapid mass loss at 300-400° C. (FIG. 7A). After pre-treatment with Et₃N the TG curve shows a more gradual mass loss from 100-400° C. (FIG. 7B). This same curve is seen after LTLP-H with a gradual mass loss from 100-400° C. (FIG. 7C). On the other hand, the derivative thermogravimetric (DTG) curve indicates the moisture loss at 100° C. and rapid degradation at 350° C. (FIG. 7A). FIG. 7B indicates two areas of degradation at 175° C. and 350° C. After LTLP-H the ET₃N pre-treated wet hard wood lignin shows a similar rapid degradation at 175° C. and degradation at 350° C. (FIG. 7C).

### Discussion of Examples 1-4

Unmodified lignin streams must be pre-treated before LTLP-H is effective. Significant yields of solubilized products were obtained utilizing the NaOH and Et₃N pre-treatments followed by LTLP-H: 81.5-98.4 wt % db and 81.5-93.4 wt % db, respectively. The switchgrass supercritical hydrolysis lignin indicated a lower yield at 48.9 wt % db. The ¹H NMR, FTIR, TG and DTG spectra indicate dramatic lignin structure modification.

It has been shown that the organosolv industrial stream may result in a maximum liquid oil yield of 57 wt %. Other industrial lignin streams subjected to LTLP-H included supercritical and enzymatic hydrolysis lignins. These lignins contained higher molecular weight species; therefore, pre-treatment steps were, in some embodiments, utilized. Pre-treatments utilized were 5% ammonium hydroxide solution and 5% calcium hydroxide solution, refluxed with the lignin for 6 hours at 125° C. The yields were lower for the supercritical lignin stream at 22 wt % liquid oil using calcium hydroxide pre-treatment while the enzymatic lignin stream produced 23 wt % with an identical pre-treatment. ¹H NMR revealed complex polymeric spectra of the lignins prior to LTLP-H with unresolved functionalities. After LTLP-H, the spectra indicated resolvable peaks suggesting the breakage of polymeric ether bonds yielding smaller molecular weight chemical species. Resolvable functionalities included methyl and methylene groups at 0.0-1.6 ppm, methylene groups and aliphatic alcohols at 1.6-2.2.0 ppm, methyl- and benzyl-substituted aromatics and alpha carbonyls at 2.2-3.0 ppm, and lastly aliphatic protons adjacent to oxygen at 3.0-4.2 ppm.

The present invention, for the first time, unexpectedly achieved improved utilization of lignin by dissolving a lignin stream directly into a solvent and/or utilizing pre-treatment steps to enhance solubility that was otherwise not achievable in the field of lignins. Secondly, the dissolved lignin streams are subjected to low temperature, low pressure-hydrogenation (LTLP-H) to liquefy the dissolved lignin into stable oil that can be further upgraded into higher-end products such as transportation fuels, thermoset plastics, and resins. LTLP-H was performed on soluble lignin streams at room temperature and 1 atm pressure using 10% Pd/C catalyst for 16 hours, which was not otherwise achieved in lignins prior to the discovery of the present invention.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed:

1. A method of producing a stable lignin phenolic oil, said method comprising:
providing a lignin;
pre-treating the lignin with a base solution, wherein the base solution has a pH of 8 or above; and
hydrogenating the pre-treated lignin to produce a stabilized lignin phenolic oil.

2. The method of claim 1, wherein the base solution has a pH of between 8 and 11.

3. The method of claim 1, wherein the lignin is selected from the group consisting of organosolv lignin, Kraft lignin, supercritical hydrolysis lignin, steam explosion lignin, enzymatic hydrolysis lignin, acetosolv lignin, milled wood lignin, and black liquor lignin.

4. The method of claim 1, wherein said pre-treating the lignin with a base solution is carried out at a temperature of between 15° C. to 200° C. and for a time of no less than 15 minutes.

5. The method of claim 4, wherein said pre-treating is carried out at a temperature of between 100° C. to 150° C. and for a time of between 2 hours and 6 hours.

6. The method of claim 1, wherein the base solution is a hydroxide solution.

7. The method of claim 6, wherein the hydroxide is selected from the group consisting of sodium hydroxide, ammonium hydroxide, calcium hydroxide, triethylamine hydroxide, potassium hydroxide, lithium hydroxide, and magnesium hydroxide.

8. The method of claim 1, wherein the base solution has a base concentration of between 1% to 25%.

9. The method of claim 8, wherein the base solution has a base concentration of about 5% or about 10%.

10. The method of claim 1 further comprising:
treating the lignin or lignin phenolic oil with an agent selected from the group consisting of triethylamine, sodium carbonate, sodium bicarbonate, alcohols, and boric acid.

11. The method of claim 1, wherein said hydrogenating is carried out at a temperature of less than 150° C. and at a pressure of less than 100 bar (absolute).

12. The method of claim 11, wherein said hydrogenating is carried out at a temperature of 10° C. to 100° C.

13. The method of claim 11, wherein said hydrogenating is carried out at a pressure of 0.05 bar (absolute) to 50 bar (absolute).

14. The method of claim 11, wherein said hydrogenating is carried out at a temperature of 15° C. to 50° C. and a pressure of 0.5 bar (absolute) to 10 bar (absolute).

15. The method of claim 11, wherein said hydrogenating is carried out at a temperature of 20° C. to 25° C. and a pressure of about 1 bar (absolute).

16. The method of claim 1, wherein said hydrogenating is carried out in the presence of a catalyst selected from the group consisting of Pd, Ru, Ru+Pd, Pt, Raney Ni, Ni, CoMo, and NiMo.

17. The method of claim 16, wherein the catalyst is Pd.

18. The method of claim 16, wherein the catalyst is Pd on activated carbon (Pd/C).

19. The method of claim 1, wherein the stabilized lignin phenolic oil contains a reduced number of polymeric ether bonds compared to the lignin prior to said pre-treating the lignin.

20. The method of claim 1, wherein the stabilized lignin phenolic oil includes methyl and methylene groups, methylene groups and aliphatic alcohols, methyl- and benzyl-substituted aromatics and alpha carbonyls, and aliphatic protons adjacent to oxygen.

21. A method of producing a stable lignin phenolic oil, said method comprising:
providing a non-recalcitrant lignin;
solubilizing the lignin in a solvent; and
hydrogenating the solubilized lignin to produce a stabilized lignin phenolic oil.

22. The method of claim 21, wherein the solvent is selected from group consisting of a C₁ to C₆ alcohol and a C₂ to C₆ ether.

23. The method of claim 22, wherein the solvent is selected from the group consisting of methanol and 1,4-dioxane.

24. The method of claim 21, wherein said hydrogenating is carried out at a temperature of less than 150° C. and at a pressure of less than 100 bar (absolute).

25. The method of claim 24, wherein said hydrogenating is carried out at a temperature of 10° C. to 100° C.

26. The method of claim 24, wherein said hydrogenating is carried out at a pressure of 0.05 bar (absolute) to 50 bar (absolute).

27. The method of claim 24, wherein said hydrogenating is carried out at a temperature of 15° C. to 50° C. and a pressure of 0.5 bar (absolute) to 10 bar (absolute).

28. The method of claim 24, wherein said hydrogenating is carried out at a temperature of 20° C. to 25° C. and a pressure of about 1 bar (absolute).

29. The method of claim 21, wherein said hydrogenating is carried out in the presence of a catalyst selected from the group consisting of Pd, Ru, Ru+Pd, Pt, Raney Ni, Ni, CoMo, and NiMo.

30. The method of claim 29, wherein the catalyst is Pd.

31. The method of claim 29, wherein the catalyst is Pd on activated carbon (Pd/C).

32. The method of claim 21, wherein the stabilized lignin phenolic oil contains a reduced number of polymeric ether bonds compared to the lignin prior to said solubilizing the lignin.

33. The method of claim 21, wherein the stabilized lignin phenolic oil contains methyl and methylene groups, methylene groups and aliphatic alcohols, methyl- and benzyl-substituted aromatics and alpha carbonyls, and aliphatic protons adjacent to oxygen.
